(19) United States
(12) Patent Application Publication
(10) Pub. No.: US 2026/0204589 A1
(43) Pub. Date: Jul. 16, 2026

(54) ELECTRODE LAMINATE MODULE

(71) Applicant: TOYOTA JIDOSHA KABUSHIKI KAISHA, Toyota-shi (JP)

(72) Inventor: Yushi SUZUKI, Mishima-shi (JP)

(73) Assignee: TOYOTA JIDOSHA KABUSHIKI KAISHA, Toyota-shi (JP)

(21) Appl. No.: 19/377,098

(22) Filed: Nov. 3, 2025

(30) Foreign Application Priority Data
Jan. 10, 2025 (JP) 2025-004139

(51) Int. Cl. H01M 4/66; H01M 4/70

(52) U.S. Cl. CPC H01M 4/668; H01M 4/661; H01M 4/70

(57) ABSTRACT

An electrode laminate module according to the present disclosure includes a plurality of electrode laminates, a metal foil, and a metal-vapor-deposited resin layer, in which each of the electrode laminates includes at least a first active material layer, a separator layer, and a second active material layer, in this order, the first active material layer of each of the electrode laminates is in contact with the metal foil, thus electrically connecting a plurality of the first active material layers to each other in parallel, the second active material layer of each of the electrode laminates is in contact with a vapor-deposited metal film of the metal-vapor-deposited resin layer, thus electrically connecting a plurality of the second active material layers to each other in parallel, and the electrode laminate module is folded or is wound such that the metal foil faces outward from an outer-side face thereof.

### CROSS-REFERENCE TO RELATED APPLICATION

This application claims priority to Japanese Patent Application No. 2025-004139 filed on January 10, 2025. The disclosure of the above-identified application, including the specification, drawings, and claims, is incorporated by reference herein in its entirety.

### BACKGROUND

### 1. Technical Field

The present disclosure relates to an electrode laminate module.

### 2. Description of Related Art

The electrode laminate module is made by accommodating an electrode laminate including at least a cathode active material layer and an anode active material layer in an outer encasement or the like. In recent years, electrode laminate modules, i.e., foldable batteries, which include a plurality of the electrode laminates electrically connected to each other, and which also have portions between the electrode laminates in which no electrode laminate is disposed, are being studied. Such a foldable battery has advantages such as allowing capacity of the electrode laminate module to be easily adjusted to any value by cutting at a portion where no electrode laminates are disposed, and thereby enabling the size of the electrode laminate module to be reduced by bending at portions where no electrode laminates are disposed.

For example, Japanese Unexamined Patent Application Publication No. 7-169453 (JP 7-169453 A) discloses a battery in which a battery element where an internal cathode current collector, made of a resin film having a metal coating layer bearing a cathode active material, a separator, and an internal anode current collector made of a resin film having a metal coating layer bearing an anode active material, being disposed between opposing flat and non-porous cathode and anode current collectors that also serve as outer encasements, and also at least part of end portions of the metal coating layers are electrically connected to inner faces of the outer encasement of the same polarity, and a peripheral region

of the outer encasement is sealed with a sealing material that also serves as electrical insulation, thereby hermetically sealing the inside of the battery. The battery described in JP 7-169453 A is said to satisfy market demands such as being light in weight, small in size, thin, having a large capacity, having a long life, being low in price, and so forth.

Also, Japanese Unexamined Patent Application Publication No. 2017-33912 (JP 2017-33912 A) discloses a flexible battery including a first substrate, a second substrate, a first unit cell and a second unit cell that are arrayed in a length direction of the first substrate and the second substrate, between the first substrate and the second substrate, in which the first and second unit cells are electrically connected to each other. The flexible battery described in JP 2017-33912 A is said to be thin-film shaped and easily bendable.

### SUMMARY

Conventional flexible batteries have used a resin film having a metal coating layer as a cathode current collector and/or an anode current collector that bears a cathode active material layer and/or an anode active material layer, in order to reduce weight of the battery, and taking permeation of moisture into the electrode laminate into consideration, it has been necessary to accommodate the battery in an outer encasement or the like.

Accordingly, an object of the present disclosure is to provide an electrode laminate module that is lightweight, while suppressing moisture permeation into the electrode laminate.

The present disclosure achieves the above object by the following means.

### First Aspect

An electrode laminate module including a plurality of electrode laminates, a metal foil, and a metal-vapor-deposited resin layer, in which

each of the electrode laminates includes at least a first active material layer, a separator layer or a solid electrolyte layer, and a second active material layer, in this order,

the first active material layer of each of the electrode laminates is in contact with the metal foil, thus electrically connecting a plurality of the first active material layers to each other in parallel,

the second active material layer of each of the electrode laminates is in contact with a vapor-deposited metal film of the metal-vapor-deposited resin layer, thus electrically connecting a plurality of the second active material layers to each other in parallel,

the electrode laminate module further includes sealed portions, each in which, each of the electrode laminates is sealed with by the metal foil, the metal-vapor-deposited resin layer, and a resin sealing member that surrounds a peripheral portion of the electrode laminate, and non-sealed portions other than the sealed portions, as viewed from a laminating direction of the metal foil and the metal-vapor-deposited resin layer, and

the electrode laminate module is folded or is wound such that the metal foil faces outward from an outer-side face of the electrode laminate module.

### Second Aspect

The electrode laminate module according to the First Aspect, in which the electrode laminate module is folded by bending the metal foil and the metal-vapor-deposited resin layer at the non-sealed portions, such that the metal foil faces outward from the outer-side face of the electrode laminate module.

### Third Aspect

The electrode laminate module according to the First or Second Aspect, in which dimensions of the separator layer or the solid electrolyte layer, and dimensions of one of the first and the second active material layers, are greater than dimensions of the other of the first and the second active material layers, as viewed from the laminating direction of the electrode laminate, and

the resin sealing member is in contact with a peripheral portion of the separator layer or the solid electrolyte layer, and/or a peripheral portion of the one of the first and the second active material layers, but is not in contact with a peripheral portion of the other of the first and the second active material layers.

### Fourth Aspect

The electrode laminate module according to any one of the First to Third Aspects, in which the vapor-deposited metal film and the metal foil do not overlap each other at the non-

sealed portions, as viewed from the laminating direction of the metal foil and the metal-vapor-deposited resin layer.

### Fifth Aspect

The electrode laminate module according to any one of the First to Fourth Aspects, in which a thickness of the vapor-deposited metal film is 1.0 μm or less.

According to the present disclosure, an electrode laminate module, which is lightweight, can be provided, while suppressing moisture permeation into the electrode laminate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for describing an electrode laminate module of the present disclosure;

FIG. 2 is a schematic diagram for describing a conventional electrode laminate module;

FIG. 3 is a schematic diagram for describing the electrode laminate module of the present disclosure;

FIG. 4 is an image of the electrode laminate module of the present disclosure according to Example 1; and

FIG. 5 is a schematic diagram for describing the first embodiment.

### DETAILED DESCRIPTION OF EMBODIMENTS

An embodiment of the present disclosure will be described below in detail. Note that the present disclosure is not limited to the following embodiment, and various modifications may be made without departing from the scope of the present disclosure. Also, the same elements are denoted by the same signs throughout the drawings, and description thereof will not be repeated.

### Electrode Laminate Module

An electrode laminate module according to the present disclosure includes a plurality of electrode laminates, a metal foil, and a metal-vapor-deposited resin layer, in which

each of the electrode laminates includes at least a first active material layer, a separator layer or a solid electrolyte layer, and a second active material layer, in this order,

the first active material layer of each of the electrode laminates is in contact with the metal foil, thus electrically connecting a plurality of the first active material layers to each other in parallel,

the second active material layer of each of the electrode laminates is in contact with a vapor-deposited metal film of the metal-vapor-deposited resin layer, thus electrically connecting a plurality of the second active material layers to each other in parallel,

the electrode laminate module further includes sealed portions, each in which, each of the electrode laminates is sealed with by the metal foil, the metal-vapor-deposited resin layer, and a resin sealing member that surrounds a peripheral portion of the electrode laminate, and non-sealed portions other than the sealed portions, as viewed from a laminating direction of the metal foil and the metal-vapor-deposited resin layer, and

the electrode laminate module is folded or is wound such that the metal foil faces outward from an outer-side face of the electrode laminate module.

According to the electrode laminate module described above, the weight can be reduced while suppressing moisture permeation into the electrode laminate.

As illustrated in FIG. 2, the electrode laminate module includes a plurality of electrode laminates 200, a sealing member 260 surrounding each of the electrode laminates 200, and two metal-vapor-deposited resin layers 240. The electrode laminates 200 are sealed by the sealing member 260 and the two metal-vapor-deposited resin layers 240, thereby reducing the weight of the electrode laminate module. However, the metal-vapor-deposited resin layer 240 has low gas barrier properties, and accordingly moisture cannot be suppressed from permeating into the electrode laminates 200. For this reason, suppressing moisture penetration into the electrode laminates 200 by folding the electrode laminate module, and thereafter performing accommodation thereof in an outer encasement or the like, has been studied, but there is concern that this might lead to increase in the number of components in the electrode laminate module, increase in the mass of the electrode laminate module, and so forth.

In contrast, the electrode laminate module according to the present disclosure includes the electrode laminates, the sealing member surrounding each of the electrode laminates, metal foil, and the metal-vapor-deposited resin layer, and is folded or is wound such that the metal foil faces outward from the outer-side face thereof. The provision of the metal-vapor-deposited resin layer enables the electrode laminate module to be made lighter, and the electrode laminate module is folded such that the metal foil with high gas barrier properties faces outward from the outer-side face thereof, thereby suppressing moisture from penetrating into the electrode laminate. The electrode laminate module according to the present disclosure can be accommodated in an outer encasement to further suppress moisture permeation, or can be used as is without being accommodated in an outer encasement.

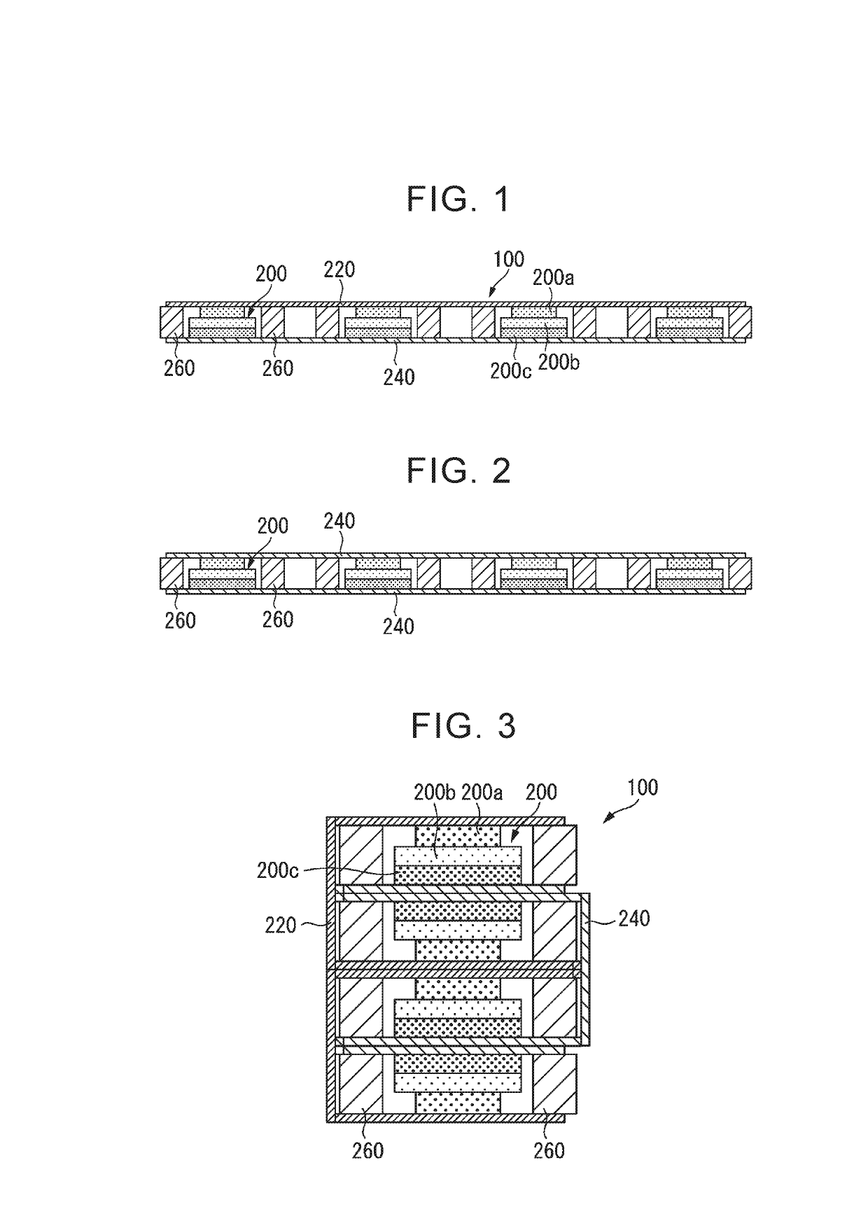

One embodiment of the present disclosure is illustrated in FIGS. 1 and 3, but the present disclosure is not limited thereto. An electrode laminate module 100 includes a plurality of the electrode laminates 200, sealing members 260 surrounding each of the electrode laminates 200, a metal foil 220, and the metal-vapor-deposited resin layer 240, and the electrode laminate module 100 is folded such that the metal foil 220 faces outward from the outer-side face thereof. This enables moisture permeation into the electrode laminate to be suppressed, and also providing the metal-vapor-deposited resin layer 240 enables reduction in the weight of the electrode laminate module 100.

In the present disclosure, the electrode laminate module has the sealed portions and the non-sealed portions. In the sealed portions, each of the electrode laminates is sealed by the metal foil, the metal-vapor-deposited resin layer, and the resin sealing member that surrounds the peripheral portion of the electrode laminate. Also, the electrode laminate module may be folded by bending the metal foil and the metal-vapor-deposited resin layer at the non-sealed portions. Here, "sealing" means sealing the internal space, which enables moisture permeation from the external space into the internal space to be suppressed.

In the present disclosure, the electrode laminate module may be further accommodated in an outer encasement or the like in this folded state. Examples of the outer encasement include resins such as polypropylene (PP) epoxy resin, and so forth, but are not limited to these.

### Electrode Laminate

In the present disclosure, the electrode laminates are provided to the electrode laminate module, and each of the electrode laminates includes at least a first active material layer, a separator layer or a solid electrolyte layer, and a second active material layer, in this order.

In the present disclosure, the first active material layer of each of the electrode laminates is in contact with the metal foil, thus electrically connecting the first active material layers to each other in parallel, and also the second active material layer of each of the electrode laminates is in contact with the vapor-deposited metal film of the metal-vapor-deposited resin layer, thus electrically connecting the second active material layers to each other in parallel.

In the present disclosure, the electrode laminate may be a liquid-based electrode laminate or a solid electrode laminate. With respect to the present disclosure, the term "liquid-based electrode laminate" refers to a battery that uses an electrolytic solution as an electrolyte, and the term "solid electrode laminate" refers to a battery that uses at least a solid electrolyte as the electrolyte, and thus a solid electrode laminate uses a combination of a solid electrolyte and a liquid electrolyte as the electrolyte.

In the present disclosure, the shape of the electrode laminate as viewed in the laminating direction of the electrode laminate is not limited in particular, but examples thereof include triangular, square, hexagonal, circular, and the like.

### First and Second Active Material Layers

In the present disclosure, the electrode laminate includes active material layers. Specifically, each of the electrode laminates includes first and second active material layers.

In the present disclosure, the active material layer includes at least an active material. The active material layer may further optionally contain an electrolyte, a conductive aid, a binder, and so forth. The contents of the active material, the electrolyte, the conductive aid, the binder, and so forth in the active material layer may be appropriately determined depending on the desired battery performance. The content of the active material may be, for example, 40% by mass or more, 50% by mass or more, or 60% by mass or more, and may be 100% by mass or less, or 90% by mass or less, in which the entire active material layer is 100% by mass.

In the present disclosure, the "active material" may be either a "cathode active material" or an "anode active material". For example, when the first active material layer contains a cathode active material, the second active material layer may contain an anode active material, and when the first active material layer contains an anode active material, the second active material layer may contain a cathode active material.

The material of the cathode active material is not limited in particular. Examples of the cathode active material include, but are not limited to, lithium cobalt oxide (LiCoO₂), lithium nickel oxide (LiNiO₂), lithium manganese oxide (LiMn₂O₄), LiNiCoMn, lithium nickel cobalt manganese oxide (NCM: LiCO_{1/3}Ni_{1/3}Mn_{1/3}O₂), lithium nickel cobalt aluminum oxide (LiNi_{0.8}(CoAl)_{0.2}O₂), and a hetero-element-substituted Li-Mn spinel having a composition represented by Li₁₊ₓMn_{2-x-y}M_{y}O₄ (where M is one or more metal elements selected from Al, Mg, Co, Fe, Ni, and Zn), or the like.

The material of the anode active material is not limited in particular. The anode active material may be, for example, metallic lithium, or a material capable of intercalating and deintercalating metal ions such as lithium ions or the like. Examples of materials capable of intercalating and deintercalating metal ions such as lithium ions or the like include alloy-based anode active materials, carbon materials, lithium titanate (Li₄Ti₅O₁₂), and so forth, but are not limited to thereto.

The alloy-based anode active materials are not limited in particular, and examples thereof include Si-alloy-based anode active materials and Sn-alloy-based anode active materials. Examples of the Si-alloy-based anode active materials include silicon, silicon oxides, silicon carbides, silicon nitrides, and solid solutions thereof. The Si alloy-based anode active material can also contain metal elements other than silicon, such as for example, iron, cobalt, antimony, bismuth, lead, nickel, copper, zinc, germanium, indium, tin, titanium, and so forth. Examples of the Sn-alloy-based anode active materials include tin, tin oxides, tin nitrides, and solid solutions thereof. Also, the Sn alloy-based anode active material can contain metal elements other than tin.

The carbon materials are not limited in particular, and examples thereof include hard carbon, soft carbon, graphite, and so forth.

The form of the active material is not limited in particular, and may be, for example, particulate. When the active material is particulate, the particle size D₅₀ of the active material may be, for example, 1 nm or more, 5 nm or more, or 10 nm or more, and may be 500 μm or less, 100 μm or less, 50 μm or less, or 30 μm or less. Note that the particle size D₅₀ is defined as the particle size (median diameter) corresponding to 50% of the volume-based cumulative particle size distribution as determined by a laser diffraction and scattering method.

In the present disclosure, a solid electrolyte optionally contained in the active material layer is selected depending on the form of the secondary battery. The solid electrolyte that is used may be any known solid electrolyte for secondary batteries. Examples of the solid electrolyte include inorganic solid electrolytes such as sulfide solid electrolytes, oxide solid electrolytes, and halide solid electrolytes, and so forth, and organic polymeric electrolytes and so forth such as polymeric electrolytes and so forth. Sulfide solid electrolytes and oxide solid electrolytes are preferred in particular for the electrolyte, from the perspective of heat resistance. The solid electrolyte may be particulate, for example. The solid electrolyte may be used as one type alone, or may be used as a combination of two or more types.

Examples of sulfide solid electrolytes include solid electrolytes containing an Li element, an X element (where X is at least one of P, As, Sb, Si, Ge, Sn, B, Al, Ga, and In), and an S element. Also, the sulfide solid electrolyte may further contain at least one of an O element and a halogen element. Examples of halogen elements include an F element, a Cl element, a Br element, and an I element. The sulfide solid electrolyte may be glass (amorphous) or glass ceramic. Examples of the sulfide solid electrolyte include Li₂S-P₂S₅, LiI-Li₂S-P₂S₅, LiI-LiBr-Li₂S-P₂S₅, Li₂S-SiS₂, Li₂S-GeS₂,and Li₂S-P₂S₅-GeS₂, but are not limited thereto.

Examples of oxide solid electrolytes include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ (LiPON), and so forth, but are not limited thereto. The oxide solid electrolyte may be amorphous or crystalline.

Examples of halide solid electrolytes include NaBH₄, NaB₁₀H₁₀, NaCB₉H₁₀, NaCB₁₁H₁₂, NaB₁₂Cl₁₂, and so forth, but are not limited thereto.

Examples of polymer electrolytes include polyethylene oxide (PEO), polypropylene oxide (PPO), and copolymers thereof, but are not limited thereto.

In the present disclosure, the content of the solid electrolyte in the active material layer is not limited in particular, but may be 1.0% by mass or more, 5.0% by mass or more, 10.0% by mass or more, or 13.0% by mass or more, and may be 60.0% by mass or less, 50.0% by mass or less, 40.0% by mass or less, or 30.0% by mass or less.

In the present disclosure, any known conductive aid that is used in secondary batteries may be used as the conductive aid optionally contained in the active material layer. Specific examples of the conductive aid include carbon materials such as Ketjen black (KB), vapor grown carbon fiber (VGCF), acetylene black (AB), carbon nanotubes (CNT), carbon nanofibers (CNF), carbon black, coke, graphite, and so forth. A metal material that can withstand the environment in which the battery is used can be used as the conductive aid. The conductive aid may be one type used alone or may be used in combination of two types or more. The conductive aid may be in various forms such as powder, fibers, or the like.

In the present disclosure, the content of the conductive aid in the active material layer is not limited in particular, but may be 0.1% by mass or more, 0.5% by mass or more, 1.0% by mass or more, or 3.0% by mass or more, and may be 20.0% by mass or less, 15.0% by mass or less, 10.0% by mass or less, or 8.0% by mass or less.

In the present disclosure, the binder optionally contained in the active material layer may be any known binder that is used in secondary batteries. Examples of binders include styrene butadiene rubber (SBR), carboxymethyl cellulose (CMC), acrylonitrile butadiene rubber (ABR), butadiene rubber (BR), polyvinylidene fluoride (PVDF), polytetrafluoroethylene (PTFE), and so forth. One type of binder may be used alone, or two or more types may be used in combination.

In the present disclosure, the content of the binder in the active material layer is not limited in particular, but may be 0.1% by mass or more, 0.5% by mass or more, 1.0% by mass or more, or 3.0% by mass or more, and may be 20.0% by mass or less, 10.0% by mass or less, or 8.0% by mass or less.

### Separator Layer

In the present disclosure, each of the electrode laminates may include a separator layer. Specifically, when the electrode laminate is a liquid-based electrode laminate, the electrode laminate may include a separator layer.

In the present disclosure, the separator layer may be any separator commonly used in secondary batteries, and examples thereof include those made of resins such as butadiene rubber (BR), polyethylene (PE), polypropylene (PP), polyester, polyamide, and so forth. The separator layer may have a single-layer structure or a multi-layer structure. Examples of the separator layer having a multi-layer structure include a separator layer having a two-layer structure of PE/PP, a separator layer having a three-layer structure of PP/PE/PP or PE/PP/PE, or the like. The separator layer may be made of a nonwoven fabric such as a cellulose nonwoven fabric, a resin nonwoven fabric, a glass fiber nonwoven fabric, or the like. In the present disclosure, the separator layer may further include a solid electrolyte.

In the present disclosure, the separator layer may have a greater dimension than the dimensions of the first or the second active material layer, as viewed in the laminating direction of the electrode laminate. In the present disclosure, the phrase "greater dimension" means that when two shapes are laid upon each other, one shape encompasses the other.

### Solid Electrolyte Layer

In the present disclosure, each of the electrode laminates may include a solid electrolyte layer. In the present disclosure, the solid electrolyte layer includes at least a solid electrolyte. For details of the solid electrolyte contained in the solid electrolyte layer according to the present disclosure, the above description regarding the active material layer of the present disclosure can be referenced.

In the present disclosure, the dimensions of the solid electrolyte layer may be greater than the dimensions of the first or the second active material layer, as viewed in the laminating direction of the electrode laminate.

### Metal Foil

In the present disclosure, the electrode laminate module includes a metal foil, and the electrode laminate module is folded or is wound such that the metal foil faces outward from the outer-side face thereof.

In the present disclosure, the material of the metal foil is not limited in particular, as long as having gas barrier properties, and examples thereof include copper, nickel, chromium, gold, platinum, silver, aluminum, iron, titanium, zinc, cobalt, stainless steel, aluminum alloys, and so forth. In particular, when the metal foil is connected to an active material layer containing a cathode active material, the material thereof may contain aluminum, from the perspective of ensuring oxidation resistance, and so forth.

In the present disclosure, the thickness of the metal foil may be 3 μm or more, 5 μm or more, or 10 μm or more, and may be 100 μm or less, 80 μm or less, or 50 μm or less.

### Metal-Vapor-Deposited Resin Layer

In the present disclosure, the electrode laminate module includes a metal-vapor-deposited resin layer. The metal-vapor-deposited resin layer includes at least a resin layer and a vapor-deposited metal film.

The resin layer of the metal-vapor-deposited resin layer is not limited in particular, but polyethylene terephthalate (PET), polypropylene (PP), and so forth, are preferred from the perspective of heat resistance.

In the present disclosure, the thickness of the resin layer is not limited in particular, but may be 0.1 μm or more, 0.3 μm or more, 0.5 μm or more, 1.0 μm or more, 3.0 μm or more, or 5.0 μm or more, and may be 100.0 μm or less, 80.0 μm or less, 60.0 μm or less, 30.0 μm or less, 10.0 μm or less, 8.0 μm or less, or 5.0 μm or less.

The vapor-deposited metal film is not limited in particular, but examples include copper, nickel, chromium, gold, platinum, silver, aluminum, iron, titanium, zinc, cobalt, stainless steel, aluminum alloys, and so forth, and reduction-resistant films are preferred.

In the present disclosure, the thickness of the vapor-deposited metal film is not limited in particular, but may be 1 nm or more, 3 nm or more, 10 nm or more, 50 nm or more, or 100 nm or more, and may be 1.0 μm or less, 800 nm or less, 500 nm or less, 300 nm or less, or 150 nm or less.

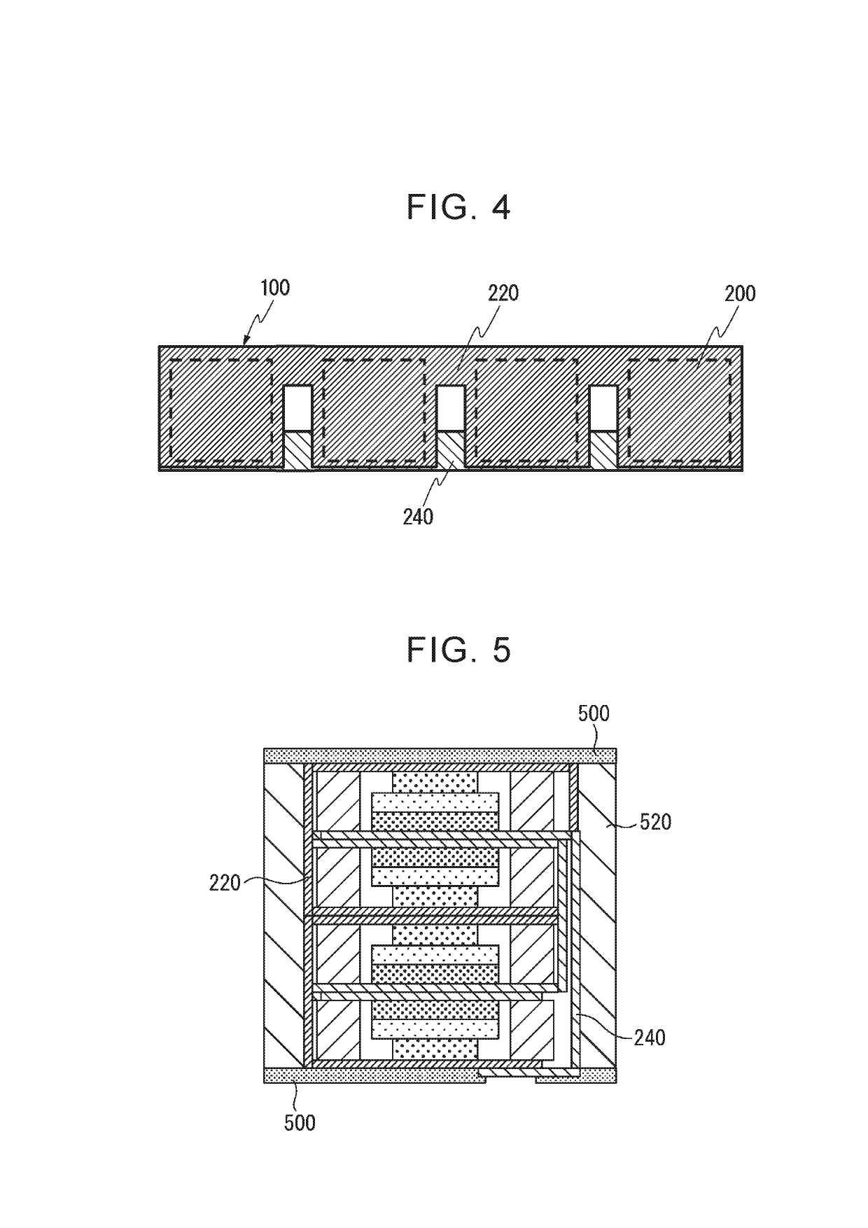

In the present disclosure, the vapor-deposited metal film and the metal foil do not need to overlap in non-sealing portions in the electrode laminate module, as viewed from the laminating direction of the metal foil and the metal-vapor-deposited resin layer. For example, as illustrated in FIG. 4 in the electrode laminate module 100 as viewed from the laminating direction of the metal foil 220 and the metal-vapor-deposited resin layer 240, the metal-vapor-deposited resin layer 240 having the vapor-deposited metal film and the metal foil 220 do not have to overlap at the non-sealed portion. This enables the vapor-deposited metal film and the metal foil to be suppressed from coming into contact with each other at the non-sealed portions when the electrode laminate module is bent at the non-sealed portions.

### Resin Sealing Member

In the present disclosure, the resin sealing member is disposed on the peripheral portion of the electrode laminate, and each of the electrode laminates is sealed by the resin sealing member, the metal foil, and the metal-vapor-deposited resin layer.

In the present disclosure, the resin sealing member is not limited in particular as long as a resin that can be fused to metal. The resin sealing member may be, but is not limited to, a thermoplastic film containing polypropylene (PP).

In the present disclosure, the shape and position of the resin sealing member are not limited in particular, as long as sealing each of the electrode laminates. That is to say, for example, the resin sealing member may be in contact with the first active material layer, the separator layer or the solid electrolyte layer, and/or the second active material layer, and the peripheral portion of the resin sealing member may be in direct contact with the vapor-deposited metal film and/or the metal foil.

Also, in the present disclosure, as viewed from the laminating direction of the electrode laminate, the dimensions of the separator layer or the solid electrolyte layer and the dimensions of the anode active material layer may be greater than the dimensions of the cathode active material layer, and also the resin sealing member may be in contact with the peripheral portion of the separator layer or the solid electrolyte layer and/or the peripheral portion of the anode active material layer, and does not have to be in contact with the peripheral portion of the cathode active material layer.

The present disclosure will be described in more detail below with reference to Examples, but the scope of the present disclosure is not limited by these Examples.

Example 1

### Fabrication of Electrode Laminate

A cathode composite material containing LiNiCoMn as a cathode active material, LiI-LiBr-Li₂S-P₂S₅ as a solid electrolyte, vapor grown carbon fiber as a conductive aid, and butadiene rubber as a binder, was prepared. Also, an anode composite material containing graphite as an anode active material, LiI-LiBr-Li₂S-P₂S₅ as a solid electrolyte, vapor grown carbon fiber as a conductive aid, and butadiene rubber as a binder, was prepared.

A cathode composite material was applied to one face of a separator layer, which was a mixture of a solid electrolyte and butadiene rubber, and an anode composite material was applied to the other face thereof, thereby fabricating four electrode laminates each having the first active material layer and the second active material layer, respectively.

### Sealing of Electrode Laminates and Fabrication of Electrode Laminate Modules

Aluminum foil was prepared as the metal foil, and a polyethylene terephthalate film on which copper was vapor-deposited, was prepared as the metal-vapor-deposited resin.

The four electrode laminates were disposed such that the first active material layer was in contact with the metal foil and also the second active material layer was in contact with the vapor-deposited metal of the metal vapor-deposited resin, and a thermoplastic film containing polypropylene was disposed around each of the four electrode laminates. Thereafter, an electrode laminate module was fabricated by heating under conditions of 150 °C for 1 minute under reduced pressure. At this time, the electrode laminate was sealed with the thermoplastic film, the metal foil, and the metal-deposited resin.

### Folding of Electrode Laminate Module

The electrode laminate module was folded. In the electrode laminate module after folding, the metal foil faced outward from the outer-side face thereof, as illustrated in the cross-sectional view in FIG. 3.

### Accommodation of Electrode Laminate Module

As illustrated in FIG. 5, upper and lower faces of the electrode laminate in the laminating direction were covered with polypropylene film 500, and the periphery of the folded electrode laminate module was partially covered with epoxy resin 520.

Example 2

An electrode laminate module according to Example 2 was fabricated in the same manner as in Example 1, except that a cathode composite material was applied to one face of the separator layer and an anode composite material was applied to the other face thereof, thereby fabricating an electrode laminate including these as a second active material layer and a first active material layer, respectively, and that copper foil was used as the metal foil, and aluminum-vapor-deposited polyethylene terephthalate film was used as the metal-vapor-deposited resin.

### Evaluation

Reduction in weight of the electrode laminate modules of Example 1 and Example 2 was confirmed. In particular, the effect of reduction in weight of the electrode laminate module according to Example 1 was significant.

What is claimed is:

1. An electrode laminate module comprising:
a plurality of electrode laminates;
a metal foil; and
a metal-vapor-deposited resin layer, wherein
each of the electrode laminates includes at least a first active material layer, a separator layer or a solid electrolyte layer, and a second active material layer, in this order,
the first active material layer of each of the electrode laminates is in contact with the metal foil, thus electrically connecting a plurality of the first active material layers to each other in parallel,
the second active material layer of each of the electrode laminates is in contact with a vapor-deposited metal film of the metal-vapor-deposited resin layer, thus electrically connecting a plurality of the second active material layers to each other in parallel,
the electrode laminate module further includes sealed portions, each in which, each of the electrode laminates is sealed with by the metal foil, the metal-vapor-deposited resin layer, and a resin sealing member that surrounds a peripheral portion of the electrode laminate, and non-sealed portions other than the sealed portions, as viewed from a laminating direction of the metal foil and the metal-vapor-deposited resin layer, and
the electrode laminate module is folded or is wound such that the metal foil faces outward from an outer-side face of the electrode laminate module.

2. The electrode laminate module according to claim 1, wherein the electrode laminate module is folded by bending the metal foil and the metal-vapor-deposited resin layer at the non-sealed portions, such that the metal foil faces outward from the outer-side face of the electrode laminate module.

3. The electrode laminate module according to claim 1, wherein
dimensions of the separator layer or the solid electrolyte layer, and dimensions of one of the first and the second active material layers, are greater than dimensions of the other of the first and the second active material layers, as viewed from the laminating direction of the electrode laminate, and
the resin sealing member is in contact with a peripheral portion of the separator layer or the solid electrolyte layer, and/or a peripheral portion of the one of the first and the second active material layers, but is not in contact with a peripheral portion of the other of the first and the second active material layers.

4. The electrode laminate module according to claim 3, wherein the vapor-deposited metal film and the metal foil do not overlap each other at the non-sealed portions, as viewed from the laminating direction of the metal foil and the metal-vapor-deposited resin layer.

5. The electrode laminate module according to claim 1, wherein a thickness of the vapor-deposited metal film is 1.0 μm or less.
